(19) United States
(12) Patent Application Publication
(10) Pub. No.: US 2007/0242884 A1
(43) Pub. Date: Oct. 18, 2007

(54) Method for measuring water depths using visible images of shoaling ocean waves

(76) Inventors: John P. Dugan, Annapolis, MD (US); Cynthia C. Piotrowski, Arlington, VA (US)

Correspondence Address: PETER I. LIPPMAN, 17900 MOCKINGBIRD DRIVE, RENO, NV, 89506, US

(21) Appl. No.: 10/202,617

(22) Filed: Jul. 23, 2002

Related U.S. Application Data
(60) Provisional application No. 60/307,653, filed on Jul. 24, 2001.

(51) Int. Cl. G06K 9/46

(52) U.S. Cl. 382/190

(57) ABSTRACT

To estimate water depth, photos of shoaling ocean waves are analyzed in view of primary wave frequency and length, mean water level, and known error sources. Primary wave frequency and mean water level are found from independent surface-wave and tide-level hindcasting systems for the time and place of the photos. Primary wave length is calculated from the two-dimensional Fourier transform for various subregion sizes and maximizing the peak value as a function of subregion size. Error is reduced by analysis of the above parameters and also the noise of higher-frequency wind waves and other image artifacts such as fronts and slicks. Error residuals are reduced through statistical analysis, again using independent images. Robustness is significantly enhanced by collecting images on different days.

### SUMMARY

Photographic images of shoaling ocean waves are used to estimate the depth of water over which the waves are traveling. For a single image, the change in wavelength as the waves slow down provides the indication of shoaling depths. This method depends on: 1) accurate measurements from the image of the lengths of the longest waves, 2) independent information on the frequency of these longest waves, and 3) independent information on the mean water level at the time the image was collected. The primary innovations of this patent submission are 1) the methods for determining the primary wave frequency and the mean water level, 2) the method for measuring the primary wavelength in the image, and 3) an error reduction method. The primary wave frequency and the mean water level are determined from independent ocean surface wave and tide level hindcasting systems for the time and place of image(s) collection. The length of the primary wave is determined by calculating the 2-D Fourier transform for various subregion sizes and maximizing the peak value as a function of the subregion size. Sources and magnitudes of errors indicate, to date, tractable and/or controllable levels of uncertainty in the primary wave frequency and bandwidth, the mean water level, the wavelength measurement, and the noise of higher frequency wind waves and other image artifacts such as fronts and slicks; these validations continue. Depth estimates obtained from separate images are unbiased estimates of the true depth, and residuals in the above-mentioned errors can be reduced by computing certain statistics of results for each location from independent images. Importantly, these images can be collected on different days, yielding significant robustness in the final results.

### BACKGROUND

The U.S. Navy and U.S. Marine Corps have a need for collecting reasonably accurate water depths along inaccessible coastlines for a mission termed Rapid Environmental Assessment (REA). This need was partially satisfied as far back as World War II by taking photographs from surveillance aircraft and using them to estimate water depths along inaccessible beaches, which in many cases also were actively defended (Williams 1946, Siewell 1947). A single photograph was used to measure the change in wavelength as the longest surface gravity waves shoaled, and these values were used with the wave frequency and the dispersion relation for linear gravity waves to estimate the water depths. The wave frequency was obtained from an area of the image where the water was known to be too deep to affect the waves, so that the wavelength in that location provided an estimate of the wave frequency. Alternatively, two closely spaced images (optimally collected a moderate fraction of a wave period apart) could be used to measure the speed of the swell as it shoaled, and this, along with the wavelength, was used with the dispersion relation to estimate the water depths.

These methods were very useful in instances where no other bathymetry data were available, but they were slow and manpower intensive, not particularly accurate, and often dangerous for the aircrew. The primary technical problems were associated with making accurate measurements from the images, and limitations associated with the optical data themselves. The scale of the images was a problem due to technological limitations on the accuracy with which the location, height and orientation of the camera could be measured at the time the images were collected. This affected both methods, but particularly the second one, as it required that the relative mapping of the two images to surface coordinates be even more accurate than the absolute mapping accuracy of a single image, simply because of the necessity to measure small differences in the positions of the waves in the latter case. Also, optical images are sensitive to the slopes of surface waves, so they amplify the visual effect of the shorter wind waves, thereby increasing the noise caused by any higher frequency waves that are present in the image. The methods were only useful if the analyst could unambiguously measure the length of a narrowband swell, and not be confused by wind waves or presence of more than a single component of the swell. Thus, it was useful only on a fraction of images that exhibited essentially monochromatic swell—not very common. Specifically what fraction of images was actually useful was not published. In addition, the measurements were tediously done by hand, so they were prone to mensuration error. Finally, the mean water level at the time the images were collected typically was unknown, and this led to a significant additional level of error.

This approach has been used with individual high-resolution satellite images in more recent years (Wu and Juang 1996, Leu et al. 1999), but the method has serious limitations—as noted above—that even modern satellite data do not resolve. In particular, although accurate mapping of the data to coordinates on the surface is no longer a serious issue with modern imaging systems, either airborne or spaceborne, all the other problems remain. Little or no detailed information has been published on the performance of these methods—neither a precise quantification of their accuracy nor the fraction of time that the methods appear to work at all.

There is continuing interest in methods for long-range remote surveying of bathymetry, because such a great fraction of the earth's coastlines remains totally unsurveyed. Many new technological developments could improve this situation, but they have their own limitations. For example, airborne or satellite optical images also can be used to estimate water depths from the brightness of sunlight reflected from the bottom, but this requires rather uniform bottom type and clear water to be reasonably accurate. Also, active optical (lidar) systems have been constructed to directly measure the distance to the bottom from aircraft, but they also require clear water, and they are rather slow since they must look almost straight down to penetrate the surface. A survey launch with a multibeam sounder provides high accuracy and precision, but it can only cover a few square kilometers per hour in shallow water. Airborne lidars can only increase the coverage rate of launches by an order of magnitude to several tens of square kilometers per hour, so their cost per square kilometer of survey area is only slightly improved. Airborne passive optical time series imaging of shoaling waves has been proposed and successfully demonstrated recently (Dugan et al. 2001a) for use with the full temporally resolved wave-dispersion relation. This potentially could increase the coverage rate to several hundreds of square kilometers per hour, but the technique requires a rather sophisticated imaging system to be able to accurately map the large number of images that are required from an aircraft platform (Dugan, Evans and Bhapkar 2000, Dugan et al. 2001b).

Recent technological advances have enabled the collection of large optical images of the ocean from satellites that have sufficient resolution to spatially resolve ocean surface waves, particularly the longer waves that most respond to shoaling. The IKONOS system, for example, can provide images of up to 60 km on a side with as good as 1 m resolution on the surface. Also, theater military aircraft such as the U-2 and the future Global Hawk are expected to be able to provide high-quality images. Because of the potential availability of large numbers of geometrically accurate single images in the near future, we analyze the utility they may provide through significant refinement and improvement of this older methodology that uses single images for retrieving water depths.

Method

The following describes a very greatly refined and improved form of the methodology of using single optical images, including an algorithm that utilizes the appropriate information in available data for retrieving water depths from each image. In addition to the images with the spatial information they contain, both the tide level and the frequency of the swell are required—but we obtain reasonably good estimates of these necessary quantities, from other sources. Specifically, the invention obtains values for these quantities from forecasts (or, better yet, hindcasts) which can be estimated using modern operational ocean modeling systems. Portions of the method have been applied to sample data sets collected in recent experiments near the U.S. Army Corps of Engineers Field Research Facility (FRF), located on the Outer Banks at Duck, N.C. The specific data sets had been collected under an Office of Naval Research program called Littoral Remote Sensing (LRS) during the Shoaling Waves Experiment, “SHOWEX” (Donelan et al. 2001). These data are particularly useful for this analysis because they include a large number of images having accurate camera position and attitude data, and they are accompanied by accurate in situ measurements of the water depths. FRF also provides independent in situ measurements of the water level and the frequency-direction spectrum of the waves that were present, and these are particularly useful both to evaluate the accuracy of the results and to understand the physics contributing to errors and actual failures.

The dispersion relation for gravity waves traveling over a flat bottom of moderate depth is
ω=\sqrt{gκtan h(κh)}+\vec{κ}·\vec{μ}, (1)
where ω is the intrinsic wave frequency, g is the acceleration of gravity, h is the water depth, κ and \vec{κ} are the scalar and vector wavenumber (κ=2π/λ where λ is the wavelength), and \vec{μ} is the vector water velocity. Note that h is the local depth relative to the mean water level, which itself varies with time due to the tides. In the following, we are most interested in the longest waves, which are relatively unaffected by currents simply because of their inherent high speed, so we assume that the Doppler term (the \vec{κ}·\vec{μ} term) is unimportant. This is not true in all potential applications, so it is a definite limitation, but it is accurate enough for the present study, and accurate enough for many important ocean surveying applications. With this greatly simplifying assumption we solve explicitly for the depth,
h=κ⁻¹tan h⁻¹[ω²/gκ] (2)
and, using partial derivatives, the sensitivity of the depth upon frequency and wavenumber uncertainties can be determined as

$$\frac{Δ h}{h} = g ( κ h ) \frac{Δ w}{w} + f ( κ h ) \frac{Δκ}{κ} \qquad ( 3 )$$

as shown by Dalrymple et al. (1999), for example. Both f and g are exponential functions of κh, and they each approach the value of 2 for κh<<1. Thus, errors in h are simply dependent upon errors in both the wave frequency and length. The factor of 2 in sensitivity emerges from the square root in equation 1. Also, as κh surpasses unity or so, the errors in h due to measurement errors of the frequency and wavelength grow exponentially, quickly becoming unmanageable in deeper water. So, it is clear from the dispersion relation that accurate estimates of frequency and wavelengths are necessary, and that the method will only work for water more shallow than some small to modest fraction (perhaps on the order of ¼ or so) of the longest wavelength in the shoaling wave spectrum.

Mapping of the images from the receiver coordinates to a geodetic level surface at the ocean surface is not an issue with modem cameras, navigation and collection systems. For example, IKONOS advertises absolute accuracy of 10-20 m for the location of images on the surface of the earth, and the airborne images of Dugan, Evans and Bhapkar (2000) were mapped to within 5 m absolute locations on the surface. Thus the locations of the postings of depth results are believed to be accurate to these values, and this is adequate for the intended ocean surveying needs.

The dispersion relation applies to all ocean surface linear gravity waves, and both a broad spectrum of wind waves and more narrow-banded swell appear in most optical images of the ocean. The intensity modulations in the images are directly associated with local slopes of the waves (Walker 1994), and Dugan et al. (2001a) have shown that most of the imaged modulations appear on the linear wave dispersion surface. The local wind causes a broad band of shorter wavelengths and higher frequencies, each traveling at the speed defined by the dispersion relation, and this present method cannot uniquely separate them, whereas the method of Dugan et al. (2001a) does. The swell is composed of rather long (typically 100-200 m), lower frequency (typically 0.08-0.12 Hz) waves that have traveled into the area of interest from storms elsewhere, and the part of the wave spectrum associated with the swell typically is rather narrow banded. It is this part that sometimes can be treated separately from the rest of the waves, and used in this algorithm. The issues to be resolved eventually are: how often is this the case, and how well does it work?

The fundamental issues are the accuracies of the frequency ω and the wavenumber κ of the dominant swell, and the tide level at the time the image was collected. This method addresses these three issues directly, with innovations for all three elements.

There are other issues as well, for optical images of the ocean also exhibit other features that are associated with physical processes that are not directly associated with surface gravity waves. These include fronts, surfactant films or slicks (Ewing 1950, Peltzer et al. 1990), white horses (Wu 1988, Monahan et al. 1981), Langmuir cells (Langmuir 1938), internal waves (Apel et al. 1975, Osborne and Burch 1980, LaViolette and Arnone 1988), wind gusts (Dorman and Mollo-Christensen 1973), and other features (Soules 1970, LaViolette et al. 1980, 1990). These features occur more or less dramatically in any single image, and they potentially compete with the gravity-wave signals. The methodology of Dugan et al. (2001a) discriminates against all of them because they actually appear at different locations from the gravity-wave energy in the full 3-D frequency-wavenumber spectrum of multiimage time series; however, this new algorithm for single images cannot separate these features. Therefore in preferred practice of the invention it is important early-on to examine good-quality data to estimate the difficulty of retrieving accurate water depths and, later, examine the importance of these potential additional problems.

Now, the length of the waves in the swell band has previously been estimated by the 2-D spatial spectrum of the luminance modulations in various subregions of an ocean image (cf. Stilwell and Pilon 1974, Monaldo and Kasevich 1981). The precision of the wavelength of the peak value is directly dependent upon the analysis subregion size, with larger subregions providing better precision. That is, errors in the wavenumber, Δκ, are proportional to L⁻¹—where L is the linear dimension of the subregion in the direction of propagation of the swell. We have addressed this particular issue, see Piotrowski and Dugan (2001), and found that subregion sizes of 250 m on a side typically are adequately large to obtain reasonably accurate estimates of the lengths of the shoaling waves; and, in water less than about 8 m, 125 m subregions are large enough. Larger analysis subregions typically are better because of accompanying improvements in the precision of the estimated wavelengths; however, this has to be traded off for spatial resolution in the required retrieved depths, as the retrieved values essentially are averages over the spatial size of the analysis subregion. Thus, the subregion size sets a low-pass filter over the retrieved depth values. Our method alleviates this situation significantly—and perhaps counterintuitively—by using minimum subregion sizes, and even still further reducing the size as the calculated water depths decrease with approach to the shoreline.

The estimate of the wave frequency is just as important as the wavelength, as equation (3) shows. In all the prior uses of this method of which we are aware, the frequency has been obtained from the measured wavelength at locations where the water was known to be very deep, and using the same dispersion relation (with κh<<1 so tanh κh→1). In this case, a measurement of the peak wavelength may be used to provide an estimate of the peak frequency directly. This is not a useful single-image technique if deep water does not occur within the image, a significant limitation. The present invention follows an entirely different innovative approach—estimating the peak frequency from a high-quality regional wave-forecasting/hindcasting system. Modem wave-forecasting systems assimilate real-time data from ocean buoys and orbiting space sensors (e.g., altimeters), so they utilize all available information, and have been shown to be quite accurate for peak wave frequency, the direction this dominant wave is propagating, and the significant wave height. For purposes of initial calculations, and to establish preliminary error levels, we at first ignore the error due to estimating the peak wave frequency and use the peak wave frequency that was actually measured locally by the FRF pressure sensor array as a temporary substitute. After determining the errors in retrieved depths using this perfect estimate of the frequency, we later relax this assumption and determine the further errors due to the inaccuracy of these other sources. We believe this is a less-serious difficulty than using single images for the wavelength estimation, and we have attacked this larger problem in the analysis reported in this disclosure.

An additional source of error, as noted above, is the estimate of the tide level at the time the image was collected. After all, the retrieved water depth is relative to the mean water level at the time the image was collected, and this tide level is not known with certainty along inaccessible beaches. Our innovation for estimating the mean water level is to utilize modern high-quality tide-surge forecasting systems. We at first assume that this forecast system also is perfect, and we use the locally measured value of water level at FRF in this initial analysis. Later we relax this assumption as well, and determine the quantitative effect of this error source on the final bathymetry product. At the outset we can simply bound this error: if images are collected at random times, they will occur at random stages of the tide (which is known to be a Gaussian random variable). Thus, the error of including no tidal-stage estimate at all is at worst an unbiased increase in random noise of the depth estimate, whose magnitude is the tidal range. This does not severely affect the results in intermediate water depths (say, 10-20 m depths), except at locations where the tidal range is a significant fraction of these depths. On the other hand, it is a necessary element closer to and at the shoreline.

The algorithm that we have developed for estimating the depth is as shown in the block diagram in FIG. 1. The image data are mapped to the level of the local water surface, using ancillary data on the location and orientation of the imaging system. If necessary, small additional corrections are made to the horizontal locations of the data on the surface by using the locations of stationary points on land. In our initial experiment, the test data were collected at a known location, so small changes of a few meters were made. This has been necessary in our experience only where gross pointing errors occur, and it typically has not been required. Since we are using spatial Fourier spectra to estimate wavelengths, this is done over large enough areas that location errors of a few meters or even 10 m in absolute value are not important. Next, the overall image area is split up into overlapping rectangular subregions of either 128, 256 or 512 m on a side, and 2-D Fourier spectra calculated. The usual tapering, normalizing and detrending are performed to minimize spectral leakage. The location of the peak in spectral power is estimated adaptively. This is done by using variable subregion sizes and searching among them to obtain the maximum peak value of the swell, and the associated wavenumber is chosen for the estimate. This value is entered into the dispersion relation (2), along with the frequency estimate from a forecasting model to calculate individual depth estimates. These estimates are shifted by the value of the local tide obtained from a tide-surge forecasting system. This procedure is repeated for every image available for the region, and the depth estimates tabulated for each subregion. These tabulated values are edited for obvious wild points, and the median value then computed and returned as the final depth value from the procedure. In addition, the root mean square values of these tabulated values is used as an estimate of the depth error of the procedure.

Experimental Results

A sample optical image obtained with the Airborne Remote Optical Spotlight System (AROSS) described in Dugan et al. (2001a) on Nov. 4, 1999 during SHOWEX (Donelan et al. 2001) appears as FIG. 2. The high brightness level of the beach causes the ocean to appear very dark, but the available wide dynamic range of luminance in the captured image enables accurate locations to be determined for ground survey points. These were used along with the known location and orientation of the camera at the time each image was collected to map the image data accurately to a geodetic surface at the mean height of the ocean. This mapping is not a particular problem for typical modern satellite imagery since the collections are at much higher grazing angles and the sensor location and orientation are well measured; however, mapping is more important and sensitive for airborne data of the type collected by AROSS—because the lower grazing angles used by long-range surveillance systems are more susceptible to mapping errors (Dugan, Evans and Bhapkar 2000). In either case, the relative positions of pixels across the scene are better than 1%. Piotrowski and Dugan (2001) have found that it was important to retain spatial resolution in the images of 5 m or better for the full 3-D space-time method, and this conclusion is no different here. We have accordingly mapped the images to pixel sizes of 5 m or smaller in each case used here. The image in FIG. 3 is an enhanced version taken from the square subregion near the center of FIG. 2; it shows excellent luminance resolution of the spatial modulations of the waves. FIG. 4 shows that these modulations can be very well approximated as Gaussian.

The 2-D spatial spectrum of the image in this subregion appears as FIG. 5, and both the dominant wavelength and direction are easily determined from the well-resolved peak in the spectrum. Smoothing was done by averaging spectra from nearby subregions, just to provide a pleasing plot. The distribution function of several depth samples obtained from analysis subregions at approximately 8, 10 and 12 m depth at FRF appears as FIG. 6. At the two shallower depths, the median value is essentially unbiased relative to the survey value, and the rms value is less than 0.5 m. The third depth near 12 m exhibits larger error but it is still a useful result. Given unbiased estimates, the error in an estimate of a mean of many independent estimates is reduced approximately as the square root of the number of samples, and we therefore easily estimate the number of images required to reduce the errors to specific required levels. In these plots, the actual tide level at the time of the image collection was utilized, as was the peak wave-frequency value determined from the FRF pressure array.

### DISCUSSION AND CONCLUSIONS

This single-image method exhibits reasonably accurate estimates of water depths, provided that there is a sufficient swell signal, the signal is sufficiently narrow band, and the images can be accurately mapped to the mean level of the sea surface. The peak wavelength, peak frequency, and tide level all can be estimated separately. The peak wavelength is estimated using 2-D Fourier transforms of subregions of the image, and the peak frequency can be obtained from a wave-forecasting system, or from nearby pressure sensors for purposes of initial analysis and validation. Additional errors due to using forecasting systems for both the peak frequency and the tide level can be further evaluated if desired. If the frequency is known precisely, the root-mean-square depth errors are ˜20% of the actual depth, and this level of error is reduced significantly by averaging depth estimates from a number of independent images. Continuing validations are expected to show that such estimates are unbiased, so that resulting errors in final depth estimates—when many independent images are analyzed—fall to considerably less than 10%, a significant capability for many utilitarian applications.

The demonstrated level of accuracy justifies still-further validation for locations where the peak frequency and the tide level are not known precisely. Effects of the various assumptions noted above are being analyzed, and to-date appear entirely tractable. The issues of more complicated morphology, other visible features in the images, and effects of water currents on the results are considered less important, and amenable to control as straightforward refinements of the invention described.

FIG. 7 is a summary of the various modes for collecting the data that are necessary for this method. It illustrates the three sources of imagery as being satellites, aircraft or towers on land, but these are not exclusive. The requirement is that the camera be high enough to get a good view of the shoaling waves, and that the images be accompanied by accurate data on the location and the attitude of the camera. It also shows the sources of wave frequency data as being forecasting/hindcasting systems and wave buoys, though the best nearly always would be a hindcasting system that includes whatever buoy data are available in the vicinity of the location of interest. Finally, the tide level is illustrated as from a tide-surge forecasting/hindcasting system or a tide station. Again, the best nearly always would be a hindcasting system that includes whatever tide station data are in the vicinity of the location of interest.

FIG. 8 is a summary of the potential output modes, and they are split into general categories of surveys/mapping, environmental monitoring, model input and construction. The list is not all encompassing, but is illustrative of the wide range of applications of the bathymetry data produced.

Resources

Conception and algorithmic development of the invention were funded as an independent research and development project of Arete Associates. Certain specific data sets—i.e. essentially all of the data sets tested—were used for validation simply because they were readily in hand; equivalent or virtually fungible information leading to the same conclusions is available publicly (e.g., from IKONOS). Some of these tested data sets had been collected as part of the Shoaling Waves Experiment, which was located at FRF; and the AROSS flights were supported by the Littoral Remote Sensing Program of the Office of Naval Research. Others of these data used in test, particularly the ground-truth survey data on water depths, are a combination of data collected in Arete projects undertaken at FRF in previous years, and data collected in FRF projects—all readily available to the general public from government archives. The tide levels were provided, likewise from files made available as a service to the general public, by the tide station on the FRF pier that is operated and maintained by the National Oceanographic & Atmospheric Administration National Ocean Service.

### FIGURES

FIG. 1 is a block diagram of the retrieval algorithm that is preferred for use in practice of the invention;

FIG. 2 is a sample optical image of the nearshore at FRF—panel a) being full range of brightness across the image, and panel b) showing linear increase in the brightness of the water to show the effective variations of the waves;

FIG. 3 is an enhanced view of a small subregion from the FIG. 2 nearshore area, identified by the rectangular outline superposed on the FIG. 2 image;

FIG. 4 is a distribution function for the waves in the center of the same FIG. 3 image, showing near-Gaussianity;

FIG. 5 is a two-dimensional wavenumber spectrum of the FIGS. 2 and 3 waves;

FIG. 6 is a distribution function of depth estimates relative to in situ values near 8, 10 and 12 m depths at FRF;

FIG. 7 shows input-data collection modes used with the FIG. 1 diagram, in preferred practice of the invention; and

FIG. 8 shows output bathymetry-data utilization modes also preferably used with the FIG. 1 diagram.

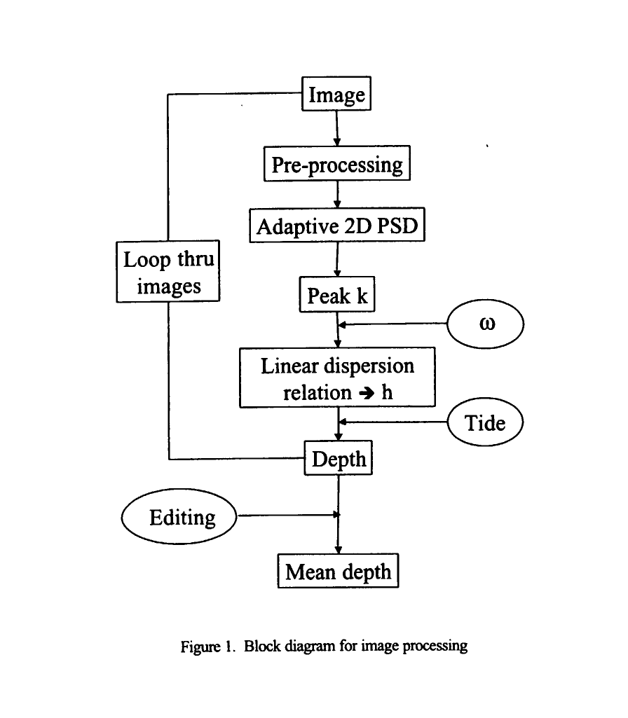

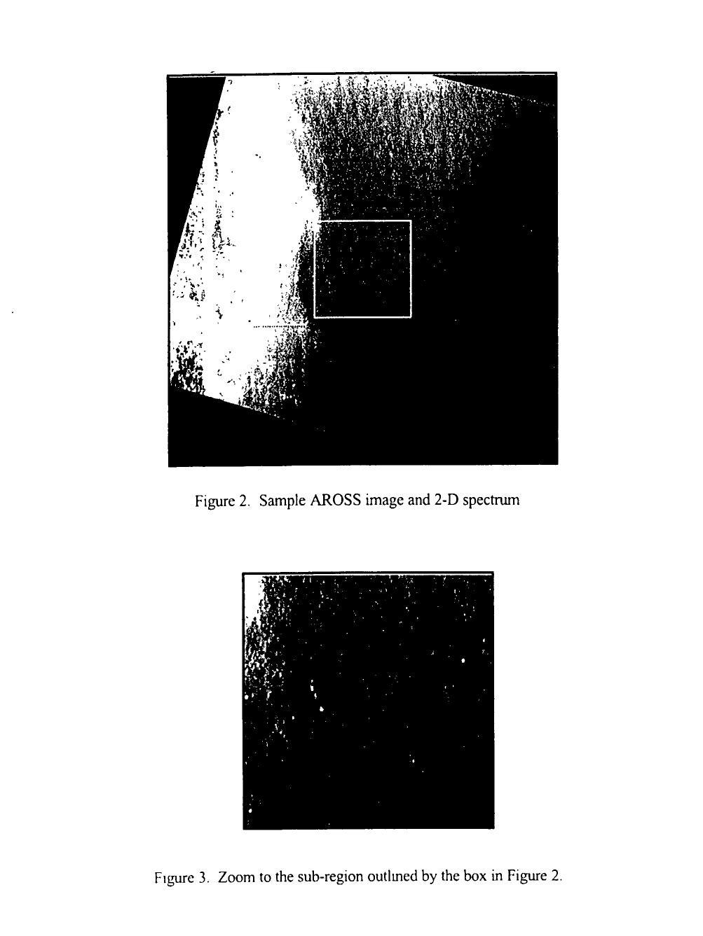

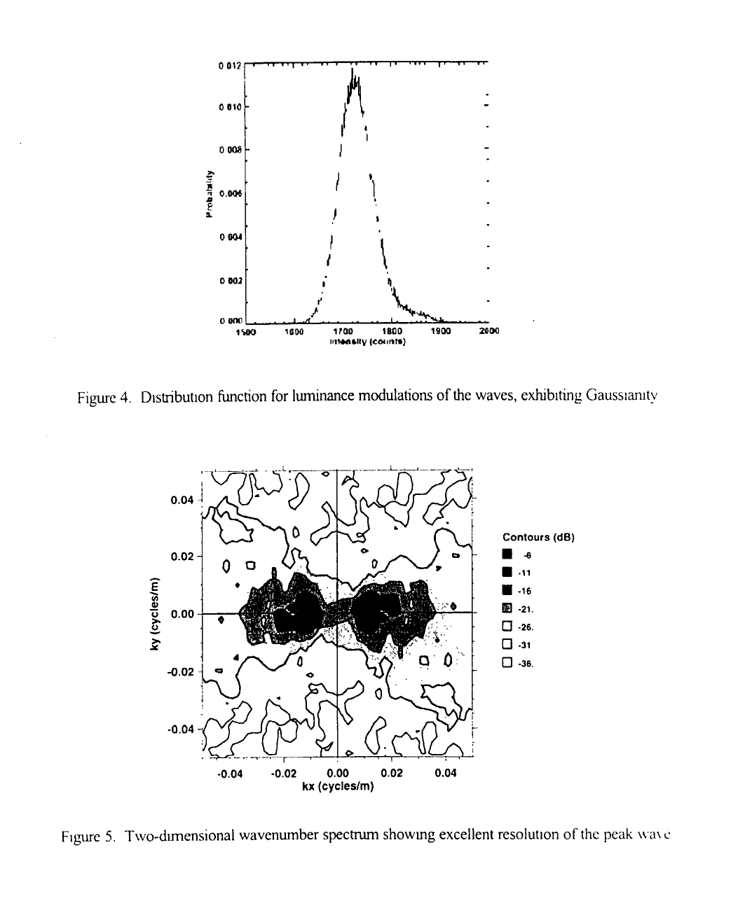

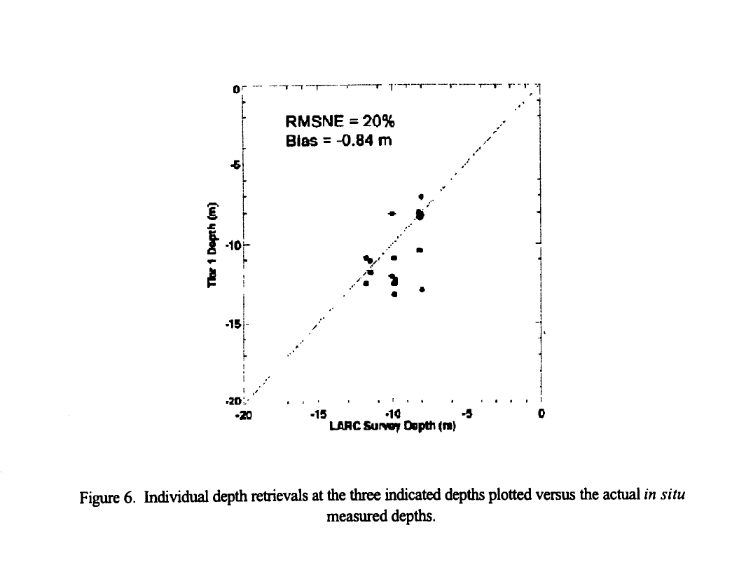

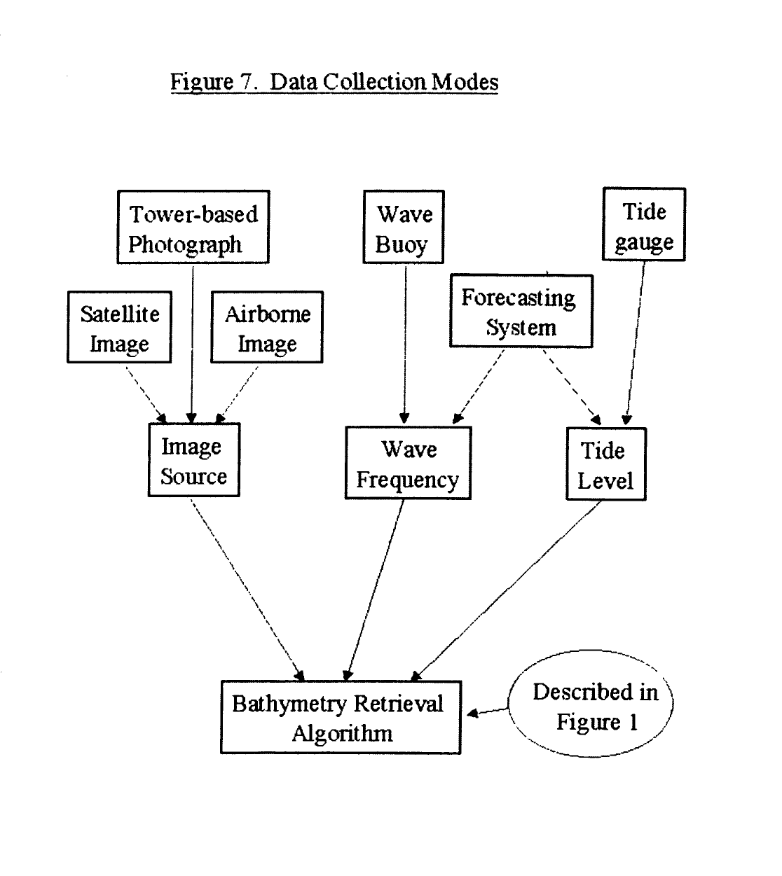

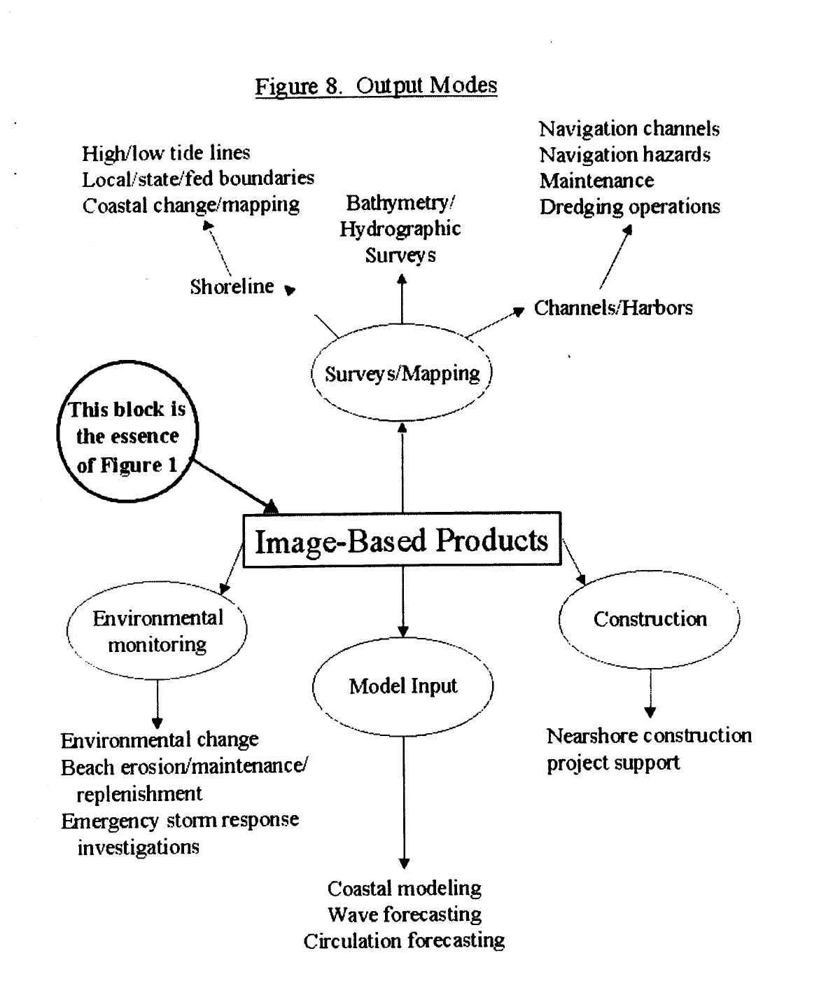

### REFERENCES

Apel, J. R., H. M. Byrne, J. R. Proni and R. L. Charnell, “Observations of oceanic internal and surface waves from the Earth Resources Technology Satellite”, J. Geophys. Res., 80(6), 865-81 (1975).
Dalrymple, R. A., A. B. Kennedy, et al., “Determining depth from remotely sensed images”, 26th Intl. Conf. Coastal Engng., Copenhagen (1998).
Donelan, Graber, et al., “The Shoaling Waves Experiment (SHOWEX)”, Bulletin of the Amer. Meteorological Society (2001, in preparation).
Dorman, C. and E. Mollo-Christensen, “Observation of the structure of moving gust patterns over a water surface (‘cat's paws’)”, J. Phys. Oceanogr., 3(1), 120-32 (1973).
Dugan, J. P., C. C. Piotrowski, et al., “Water depth and current retrievals from airborne optical measurements of surface gravity wave dispersion”, J. Geophys. Res. (in press, 2001a).
Dugan, J. P., G. J. Fetzer, et al., “Airborne optical spotlight system for remote sensing of ocean waves”, J. Atmos. and Oceanic Technol. 18(7), 1267-76 (2001b).
Dugan, J. P. and C. C. Piotrowski, “Developmental system for maritime rapid environmental assessment using UAVs”, Oceanology International 2000, Session on Rapid Environmental Assessment, Brighton, UK (Mar. 7-10, 2000).
Dugan, J. P., A. G. Evans and U. V. Bhapkar, “Airborne image navigation for ocean wave motion analysis”, Inst. of Navigation [“ION”] 2000 Natl. Mtg., Anaheim, Calif. (Jan. 26-28, 2000).
Ewing, G., “Slicks, surface films and internal waves”, J. Mar. Res., 9, 161-87 (1950).
Gotwols, B. L., R. E. Sterner, and D. R. Thompson II, “Measurement and interpretation of surface roughness changes induced by internal waves during the joint Canada-US ocean wave investigation project”, J. Geophys. Res., 93(C10), 265-81 (1988).
Langmuir, I., “Surface motion of water induced by wind”, Science, 87, 119-23 (1938).
LaViolette, P. E. and A. R. Arnone, “A tide-generated internal waveform in the Western Approaches to the Strait of Gibraltar”, J. Geophys. Res. 93(C12), 15653-67 (1988).
Leu, L.-G., Y.-Y. Kuo, et al., “Coastal bathymetry from the wave spectrum of SPOT images”, Coastal Engng. J., 41(1), 21-41 (1999).
Lubard, S. C., J. E. Krimmel, L. R. Thebaud, D. D. Evans, and O. H. Shemdin, “Optical image and laser slope meter intercomparison of high-frequency waves”, J. Geophys. Res., 85, 4996-5002 (1980).
Monaldo, F. M. and R. S. Kasevich, “Daylight imagery of ocean surface waves for wave spectra”, J. Phys. Oceanogr., 11(2), 272-83 (1981).
Osborne, A. R. and T. L. Burch, “Internal solitons in the Andaman Sea”, Science, 208, 451-60 (1980).
Peltzer, R. D., J. H. Milgram, et al., “Hydrodynamics of ship wake surfactant films”, 18th Symp. Naval Hydrodynamics, Univ Mich, Ann Arbor (1990).
Piotrowski, C. C. and J. P. Dugan, “Statistics of errors in estimating water depths from time series imaging” (manuscript in preparation, 2001).
Siewell, H. R., “Military oceanography in World War II”, The Military Engineer 39(259), 202-10 (1947).
Soules, S. D., “Sun glitter viewed from space”, Deep-Sea Res. 17, 191-95 (1970).
Stilwell, D. and R. O. Pilon, “Directional spectra of surface waves from photographs”, J. Geophys. Res., 79(9), 1277-84 (1974).
Stommel, H., “Streaks on natural water surfaces”, Weather, 6, 72-74 (1951).
Walker, R. E., Marine Light Field Statistics, N. Y., John Wiley (1994).
Williams, W. W., “The determination of gradients on enemy-held beaches”, The Geographical Journal, XIC (July): 76-93 (1946).
Wu, J. and J. T. Juang, “Application of satellite images to the detection of coastal topography”, 25th Intl Conf Coastal Engng. ASCE, Orlando Fla. (1996).
Wu, J., “Variations of whitecap coverage with wind stress and water temperature”, J. Phys. Oceanogr., 18, 1448-53 (1988).

What is claimed is:

1. We claim everything shown and disclosed herein.
